(19) United States
(12) Patent Application Publication
(10) Pub. No.: US 2022/0281531 A1
(43) Pub. Date: Sep. 8, 2022

(54) ADDITIVELY MANUFACTURED COMPOSITE PARTS HAVING VOIDS FOR WEIGHT REDUCTION

(71) Applicants: Ford Global Technologies, LLC, Dearborn, MI (US); The Regents of the University of Michigan, Ann Arbor, MI (US)

(72) Inventors: Alper Kiziltas, Sarikamis (TR); Deborah Frances Mielewski, Ann Arbor, MI (US); Nicholas Ciszewski, Ann Arbor, MI (US); Wonsuk Kim, Ann Arbor, MI (US); Alan Argento, Chelsea, MI (US)

(73) Assignees: Ford Global Technologies, LLC, Dearborn, MI (US); The Regents of the University of Michigan, Ann Arbor, MI (US)

(21) Appl. No.: 17/192,742

(22) Filed: Mar. 4, 2021

(51) Int. Cl. B62D 25/12; B29B 11/16; B29B 15/12; B29C 70/48; B29C 64/153; B29C 64/188

(52) U.S. Cl. CPC B62D 25/12; B29B 11/16; B29B 15/12; B29C 70/48; B29C 64/153; B29C 64/188; B33Y 80/00

(57) ABSTRACT

A composite part is manufactured by an additive process, which includes locating a layer of fibers, selectively depositing a matrix material in a predetermined pattern onto portions of the layer of fibers to form a matrix material layer, repeating these steps to generate a preform of the composite part, and applying heat and pressure to the preform to consolidate the layers of fiber and the layers of matrix material. During the depositing of the matrix material, voids are created within at least one layer of the matrix material by intentionally not depositing matrix material over predetermined areas of the layer of fibers, the predetermined areas configured to be within an outer boundary of the predetermined pattern of the matrix material.

### FIELD

The present disclosure relates to composite materials and methods of manufacturing the composite materials.

### BACKGROUND

The statements in this section merely provide background information related to the present disclosure and may not constitute prior art.

As the automotive industry continues to focus on reducing the weight of vehicles to meet customer expectations on fuel economy and CAFE (Corporate Average Fuel Economy) requirements, interest in alternative materials including carbon fiber composite applications has increased.

A variety of manufacturing methods, including additive manufacturing, may be used to manufacture composite materials. These methods aim to provide tailored composite structures that can be manufactured in a mass production environment, while still striving for further weight reductions.

The present disclosure addresses further reducing the weight of composite parts while taking advantage of advanced manufacturing techniques and maintaining the strength of the composite parts used in motor vehicles, among other applications.

### SUMMARY

This section provides a general summary of the disclosure and is not a comprehensive disclosure of its full scope or all of its features.

In one form of the present disclosure, a composite part is manufactured by an additive process. The additive process comprises

(a) locating a layer of fibers;

(b) selectively depositing a matrix material in a predetermined pattern onto portions of the layer of fibers to form a matrix material layer;

(c) repeating steps (a) and (b) to generate a preform of the composite part; and

(d) applying heat and pressure to the preform to consolidate the layers of fibers and the matrix material layers, wherein during the depositing of the matrix material, voids are created within at least one layer of the matrix material by intentionally not depositing matrix material over predetermined areas of the layer of fibers, the predetermined areas configured to be within an outer boundary of the predetermined pattern of the matrix material.

In variations of this method, which may be implemented individually or in any combination: the voids are configured to have a spherical shape; the spherical shape is configured to have a radius of about 0.8 mm; the voids comprise between 5-30% volume wt. % of the matrix material of the composite part; the matrix material is a thermoplastic polymer; the layer of fibers comprises continuous fibers; the layers of fibers comprise fibers selected from the group consisting of carbon, glass, poly-paraphenylene terephthalamide, cellulose, aramid, basalt, polymers, viscose, and natural materials; the layers of fibers are oriented in a common direction; the voids are evenly distributed throughout each of the layers of matrix material; and the voids are located in a central region of the composite part.

In another form of the present disclosure, a composite part is manufactured by an additive process. The additive process comprises:

(a) locating a fiber preform layer;

(b) selectively depositing an adhering agent in a predetermined pattern onto portions of the fiber preform layer;

(c) depositing a matrix material over the predetermined pattern of the adhering agent and the fiber preform layer to form a matrix material layer;

(d) removing excess matrix material;

(e) repeating steps (a) through (d) to generate a preform of the composite part;

(f) applying heat and pressure to the preform to consolidate the fiber preform layers and the matrix material layers; and

(g) removing unconsolidated portions of the fiber preform layers, wherein during the depositing of the matrix material, voids are created within at least one layer of the matrix material by intentionally not depositing matrix material over predetermined areas of the adhering agent, the predetermined areas being within an outer boundary of the predetermined pattern of the adhering agent.

In variations of this method, which may be implemented individually or in any combination: the matrix material is a thermoplastic powder; the voids have a spherical shape; the spherical shape has a radius of about 0.8 mm; and the voids comprise between 5-30% volume wt. % of the matrix material of the composite part.

In still another form of the present disclosure, a composite part is provided that comprises alternating layers of fibers and matrix material, wherein each of a plurality of layers of the alternating layers of matrix material is flanked by a layer of fibers, and predetermined areas of voids within at least one layer of the matrix material that are flanked by layers of fibers.

In variations of this composite part, which may be implemented individually or in any combination: the voids have a spherical shape; the spherical shape has a radius of about 0.8 mm; the voids comprise between 5-30% volume wt. % of the matrix material of the composite part; and the voids are evenly distributed throughout each of the plurality of layers of matrix material.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example of a composite part manufactured by an additive process of the present disclosure;

FIG. 2 is a flowchart illustrating an additive process according to one form of the present disclosure;

FIG. 3A is a plan view of a layer of fibers according to the additive process of the present disclosure;

FIG. 3B is a plan view of the layer of fibers from FIG. 3A with a matrix material selectively deposited thereon in a predetermined pattern, wherein during the depositing of the matrix material, voids are created by intentionally not depositing matrix material in predetermined areas;

FIG. 4 is a schematic cross-sectional view of the fiber layers and matrix layers of the composite part containing voids according to the present disclosure;

FIG. 5 is a flowchart of a variation of the additive process according to another form of the present disclosure;

FIG. 6 illustrates an adhering agent applied to a fiber preform layer in a predetermined pattern according to another form of the present disclosure;

FIG. 7 is a plan view of tensile test bar samples having 0.8 mm radius voids constituting 10% of the gauge length volume according to the present disclosure;

FIG. 8 is a plan view of tensile test bar samples having 0.8 mm radius voids constituting 15% of the gauge length volume according to the present disclosure;

FIG. 9 illustrates scanning electron microscope (SEM) images of cross-sections of the tensile test bar samples of FIG. 7 according to the present disclosure;

FIG. 10 illustrates scanning electron microscope (SEM) images of cross-sections of the tensile test bar samples of FIG. 8 according to the present disclosure; and

FIG. 11 illustrates a comparison of failure strain and max stress of voided and non-voided composite materials produced by the methods according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

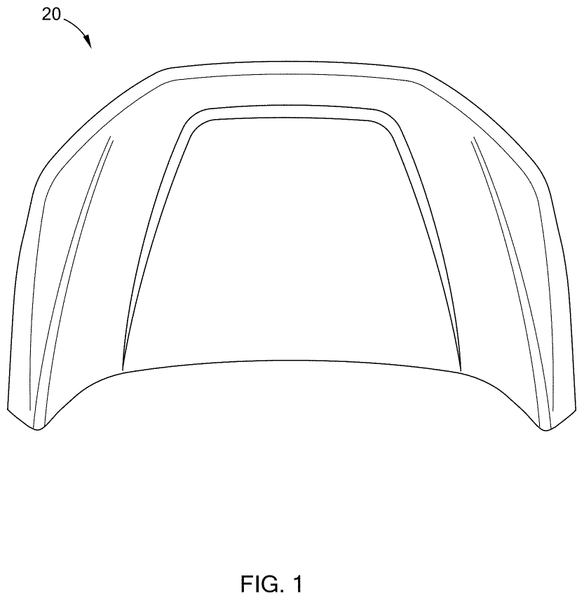

Referring to FIG. 1, an example composite part manufactured by an additive process according to the teachings of the present disclosure is illustrated and generally indicated by reference numeral 20. This composite part 20 is a hood of a motor vehicle (not shown), and is merely exemplary. Accordingly, it should be understood that the teaching of the present disclosure may be applied to a variety of parts and geometries, and also for applications other than motor vehicles while remaining within the scope of the present disclosure.

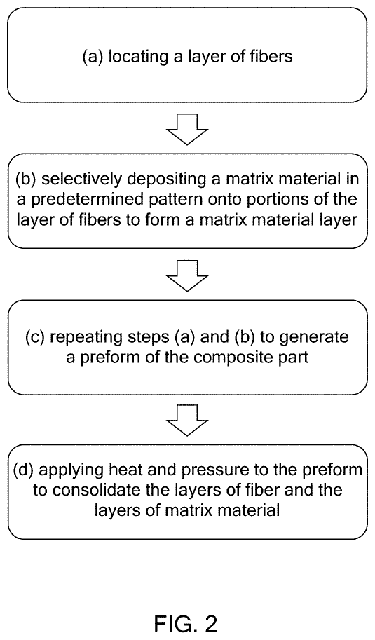

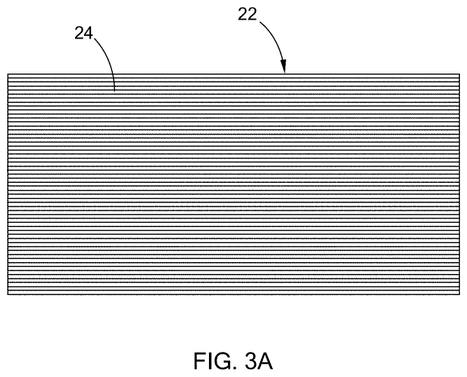

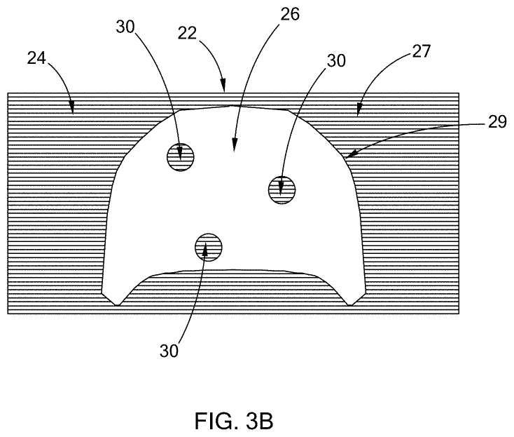

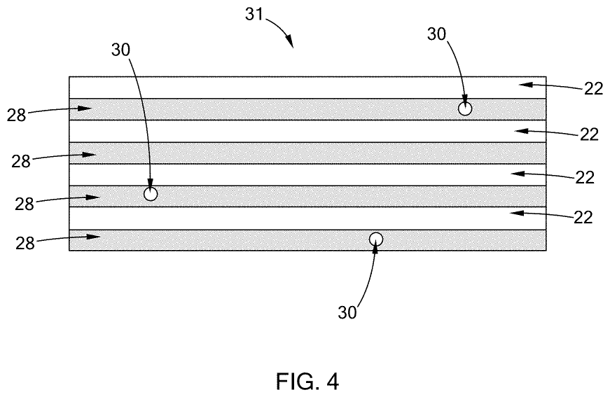

Referring now to FIG. 2, along with FIGS. 3A-3B and 4, an additive process to form the composite part 20 according to the present disclosure comprises first locating a layer of fibers 22. In one form, the layer of fibers 22 comprises continuous fibers 24 as shown in FIG. 3A. In this illustrated form, the fibers 24 are oriented in a common direction (i.e. “unidirectional”), however, it should be understood that other orientations of fibers, such as woven, may be employed. Further, the layer of fibers 22 may comprise discontinuous fibers (not shown), either random or ordered, while remaining within the scope of the present disclosure.

In one form, the fibers 24 are carbon. However, the present disclosure is not limited thereto. The fibers 24 may also be carbon, glass, the Kevlar® brand poly-paraphenylene terephthalamide, cellulose, aramid, basalt, polymers, viscose, and natural materials, among others.

With specific reference to FIG. 3B, the additive process then comprises selectively depositing a matrix material 26 in a predetermined pattern 27 onto portions of the layer of fibers 22 to form a matrix material layer 28 (FIG. 4). In one form of the present disclosure, the matrix material 26 is a thermoplastic polymer such as nylon or Polyether Ether Ketone (PEEK). However, other polymers, and not just thermoplastic polymers, may be employed while remaining within the scope of the present disclosure. Further, the present disclosure is not limited to polymer matrix materials. The predetermined pattern 27 is generated from underlying geometry of the composite part 20, and more specifically from CAD (Computer Aided Design) geometry, as is known in the art of additive manufacturing.

Referring to FIG. 3B, during the depositing of the matrix material 26, voids 30 are created within at least one of the matrix material layers 28 by intentionally not depositing matrix material 26 over predetermined areas of the layer of fibers 22. The predetermined areas are within an outer boundary 29 of the predetermined pattern 27 of the matrix material 26 so as to create voids within the final part 20, as described in greater detail below.

In one form, the voids 30 are configured to have a spherical shape. The nominal design of the voids 30 are spherical, however, after further processing of the various layers to form the composite part 20, the resulting geometry of the voids 30 deviate from this nominal spherical shape. Further, the present disclosure is not limited to spherical shaped voids 30. For example, the voids 30 may also be configured to have a square, elliptical, or other polygonal shape, among others.

In one form, the spherical voids 30 are configured to have a radius of about 0.8 mm.

In another form, the voids 30 comprise between 5-30% volume wt. of the matrix material 26 of the composite part 20.

In yet another form, the voids 30 are evenly distributed throughout each of the matrix material layers 28. However, in yet another form of the present disclosure, the voids 30 are located in a central region of the composite part 20 when the peripheral portion of the composite part 20 is subjected to higher loads during operation.

Referring again to FIG. 2 and FIG. 4, the additive process of the present disclosure then comprises repeating steps of locating a layer of fibers 22 and selectively depositing a matrix material 26 in a predetermined pattern onto portions of the layer of fibers 22 to form a matrix material layer 28 to generate a preform 31 of the composite part 20. The preform 31 of the composite part 20 comprises alternating layers of fibers 22 and matrix material layers 28 (FIG. 4), the combination of which is referred to as a “laminate.” While several matrix material layers 28 are illustrated as having at least one void 30, it should be understood that a plurality of voids 30 may be intentionally created in one or more than one matrix material layer 28. Further, at least one of the matrix material layers 28 contains at least one void 30. Thus, it should be understood that the present disclosure includes a wide variety of configurations of voids 30 disposed within the laminate.

The additive process of the present disclosure then comprises applying heat and pressure to the preform 31 to consolidate the layers of fiber 22 and the matrix material layers 28. The heat and pressure may be provided by a conventional autoclave, or other heated press/mold process as is known in the art.

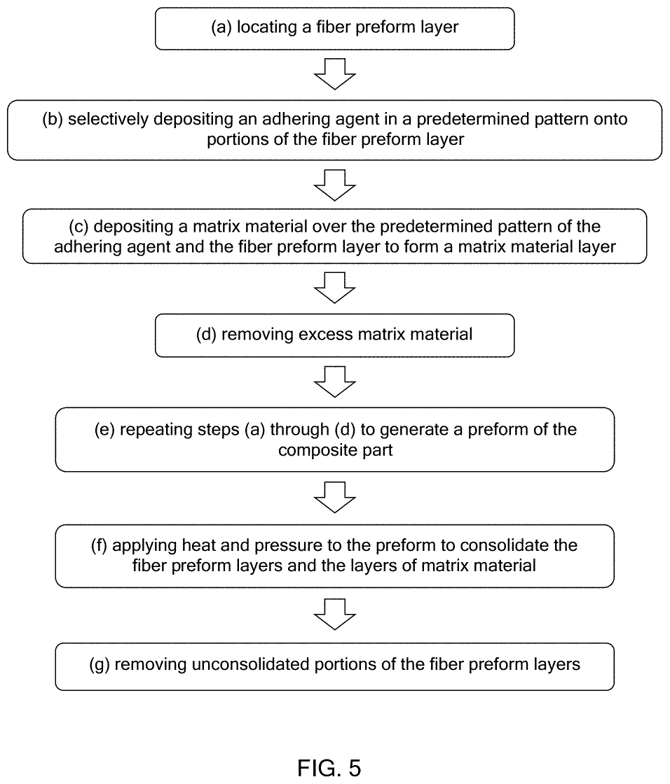

Referring now to FIG. 5, along with FIGS. 3A, 3B, 4, and 6, a variation of the aforementioned method of manufacturing the composite part 20 is illustrated. Additional details of this process may be found in U.S. Pat. Nos. 9,776,376, 10,377,080, and 10,751,987, the contents of which are incorporated herein by reference in their entirety.

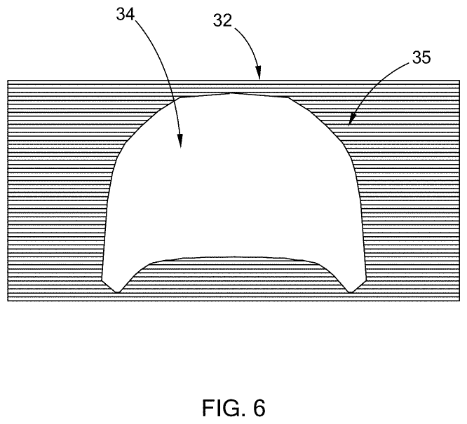

This variant of the additive process comprises first locating a fiber preform layer 32. The additive process then comprises selectively depositing an adhering agent 34 in a predetermined pattern 35 onto portions of the fiber preform layer 32 as illustrated in FIG. 6. The adhering agent 34 is generally employed to adhere, or increase the bonding strength of, the matrix material 26 to the fiber preform layer 32.

The additive process then comprises depositing the matrix material 26 over the predetermined pattern of the adhering agent 34 and the fiber preform layer 32 to form a matrix material layer 28. In one form of the present disclosure, the matrix material 26 is a thermoplastic powder such as nylon or the Polyether Ether Ketone (PEEK). However, other polymers, and not just thermoplastic polymers, may be employed while remaining within the scope of the present disclosure. Further, the present disclosure is not limited to polymer matrix materials. The predetermined pattern 27 is generated from underlying geometry of the composite part 20, and more specifically from CAD geometry, as is known in the art of additive manufacturing.

Similar to the previous additive process, during the depositing of the matrix material 26, voids 30 are created within at least one matrix material layer 28 by intentionally not depositing matrix material 26 over predetermined areas of the adhering agent 34, the predetermined areas being within an outer boundary of the predetermined pattern of the adhering agent 34.

Referring again to FIG. 5, the additive process then comprises removing excess matrix material 26.

The additive process then comprises repeating the aforementioned steps to generate a preform of the composite part 20.

The additive process then comprises applying heat and pressure to the preform to consolidate the fiber preform layers 32 and the matrix material layers 28. The heat and pressure may be provided by a conventional autoclave, or other heated press/mold process as is known in the art.

The additive process then comprises removing unconsolidated portions of the fiber preform layers 32.

Referring back to FIG. 4, in another form of the present disclosure, the composite part 20 comprises alternating layers of fibers 22 and matrix material layers 28. Each of the matrix material layers 28 is flanked by a layer of fibers 22, and predetermined areas of voids 30 within at least one matrix material layer 28 are flanked by layers of fibers 22. Not being bound by any theory, the inventors have discovered that the fibers within the layers of fibers 22 extending across the voids 30, or flanking the voids 30, provide requisite strength while the voids 30 contribute to further weight savings.

### Experimental Examples

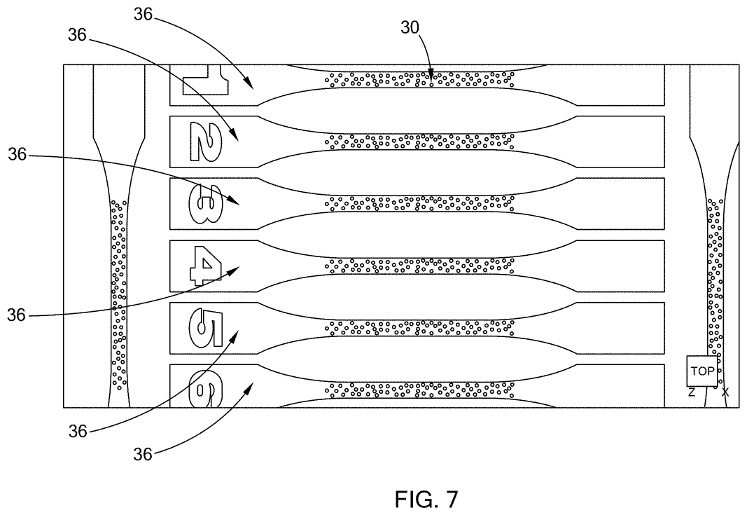

Tensile test bars 36 containing polymer matrix material with spherical voids 30 and embedded continuous fibers were designed and tested. The size and number of the spheres in this example were calculated based on how much of the gauge length volume was to be voided. As illustrated in FIG. 7, the voids 30 were configured to have a radius of 0.8 mm and comprise 10% of the gauge length volume. As shown, the voids 30 were located in a central region of the tensile test bars 36. The quantity of fibers is generally unaffected by the presence of the voids 30. As a result, stiffness and strength of the tensile test bar did not appear to be reduced.

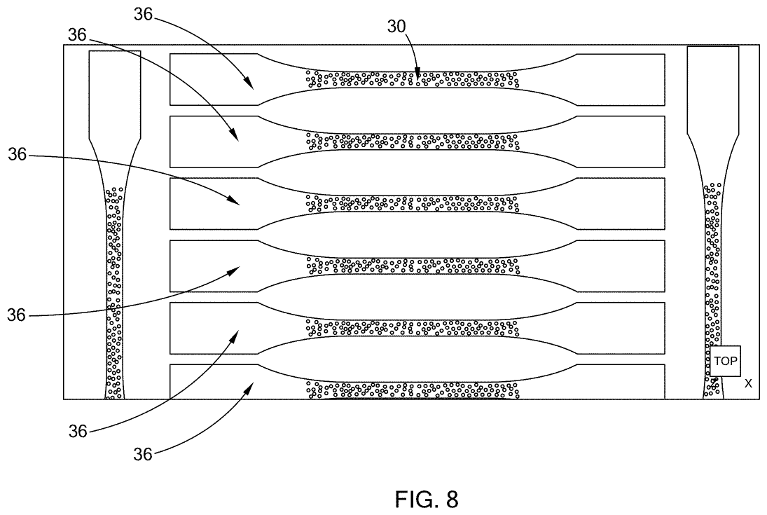

Similarly, FIG. 8 illustrates tensile test bars 36 with voids 30 configured to have a radius of 0.8 mm and comprising 15% of the gauge length volume. As shown, the voids 30 are located in a central region of the tensile test bars 36. The quantity of fibers is unaffected by the presence of the voids 30. As a result, stiffness and strength of the tensile test bar was not reduced.

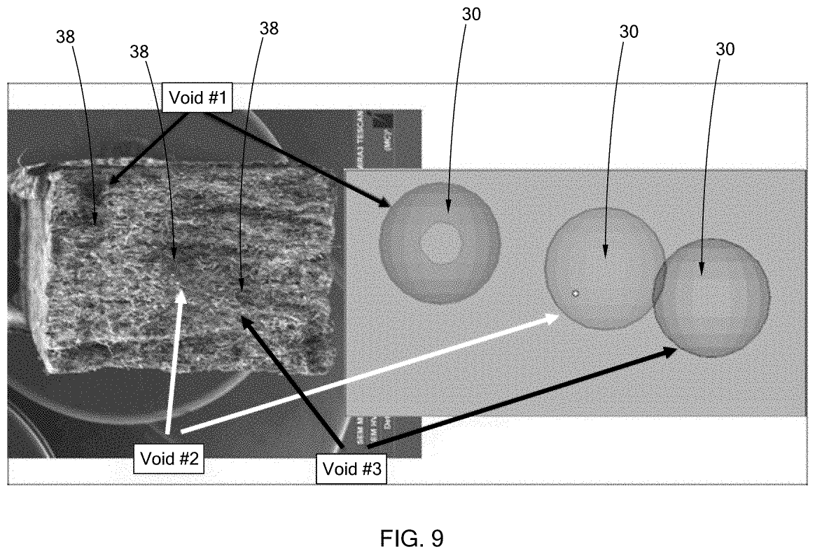

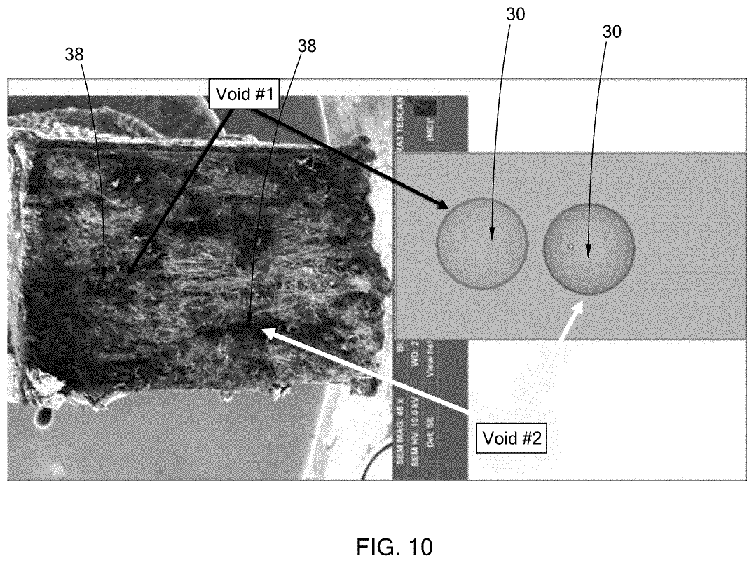

FIGS. 9 and 10 show scanning electron microscope (SEM) images of the fractured cross-sections of two samples after tensile test, along with renditions of the designed cross-sections and top view of the over-all test sample. A pattern of depressions 38 can be seen in the SEM images that roughly correspond to the locations of the voids 30 on the designed cross-section. Exact correspondence is not possible because: (1) the tensile test bars 36 change shape due to application of pressure during molding, (2) some matrix material 26 likely moves into the voids 30 during the molding heating process, and (3) the sample deforms during mechanical test causing the voids to move from their designed locations. As illustrated in FIG. 9, the voids 30 have a radius of 0.8 mm and comprise 10% of the gauge length volume. As illustrated in FIG. 10, the voids 30 have a radius of 0.8 mm and comprise 15% of the gauge length volume.

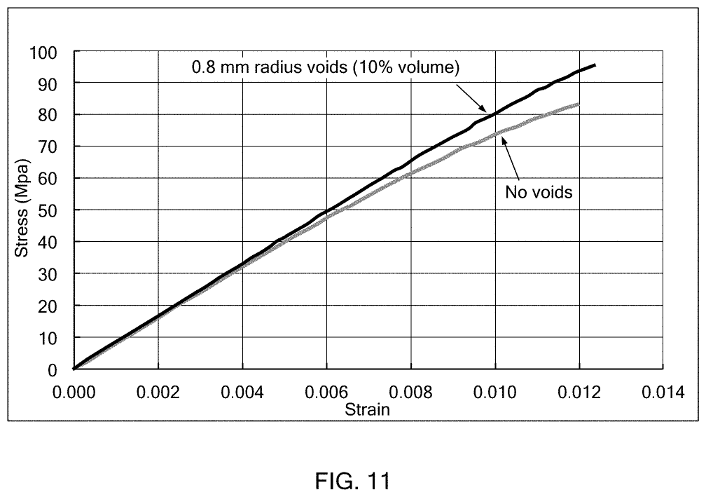

Referring now to FIG. 11, failure strain and maximum stress were compared for voided and non-voided composite materials produced by additive manufacturing. As shown, failure strain and failure stress of the voided composite materials were higher than the corresponding values of composite materials without voids.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A composite part manufactured by an additive process, the additive process comprising:
(a) locating a layer of fibers;
(b) selectively depositing a matrix material in a predetermined pattern onto portions of the layer of fibers to form a matrix material layer;
(c) repeating steps (a) and (b) to generate a preform of the composite part; and
(d) applying heat and pressure to the preform to consolidate the layers of fibers and the matrix material layers,
wherein during the depositing of the matrix material, voids are created within at least one layer of the matrix material by intentionally not depositing matrix material over predetermined areas of the layer of fibers, the predetermined areas configured to be within an outer boundary of the predetermined pattern of the matrix material.

2. The composite part according to claim 1, wherein the voids are configured to have a spherical shape.

3. The composite part according to claim 2, wherein the spherical shape is configured to have a radius of about 0.8 mm.

4. The composite part according to claim 1, wherein the voids comprise between 5-30% volume wt. % of the matrix material of the composite part.

5. The composite part according to claim 1, wherein the matrix material is a thermoplastic polymer.

6. The composite part according to claim 1, wherein the layer of fibers comprises continuous fibers.

7. The composite part according to claim 1, wherein the layers of fibers comprise fibers selected from the group consisting of carbon, glass, poly-paraphenylene terephthalamide, cellulose, aramid, basalt, polymers, viscose, and natural materials.

8. The composite part according to claim 1, wherein the layers of fibers are oriented in a common direction.

9. The composite part according to claim 1, wherein the voids are evenly distributed throughout each of the layers of matrix material.

10. The composite part according to claim 1, wherein the voids are located in a central region of the composite part.

11. A composite part manufactured by an additive process, the additive process comprising:
(a) locating a fiber preform layer;
(b) selectively depositing an adhering agent in a predetermined pattern onto portions of the fiber preform layer;
(c) depositing a matrix material over the predetermined pattern of the adhering agent and the fiber preform layer to form a matrix material layer;
(d) removing excess matrix material;
(e) repeating steps (a) through (d) to generate a preform of the composite part;
(f) applying heat and pressure to the preform to consolidate the fiber preform layers and the matrix material layers; and
(g) removing unconsolidated portions of the fiber preform layers,
wherein during the depositing of the matrix material, voids are created within at least one layer of the matrix material by intentionally not depositing matrix material over predetermined areas of the adhering agent, the predetermined areas being within an outer boundary of the predetermined pattern of the adhering agent.

12. The composite part according to claim 11, wherein the matrix material is a thermoplastic powder.

13. The composite part according to claim 11, wherein the voids have a spherical shape.

14. The composite part according to claim 13, wherein the spherical shape has a radius of about 0.8 mm.

15. The composite part according to claim 11, wherein the voids comprise between 5-30% volume wt. % of the matrix material of the composite part.

16. A composite part comprising:
alternating layers of fibers and matrix material, wherein each of a plurality of layers of the alternating layers of matrix material is flanked by a layer of fibers; and
predetermined areas of voids within at least one layer of the matrix material that are flanked by layers of fibers.

17. The composite part according to claim 16, wherein the voids have a spherical shape.

18. The composite part according to claim 17, wherein the spherical shape has a radius of about 0.8 mm.

19. The composite part according to claim 16, wherein the voids comprise between 5-30% volume wt. % of the matrix material of the composite part.

20. The composite part according to claim 16, wherein the voids are evenly distributed throughout each of the plurality of layers of matrix material.
